(19) United States
(12) Patent Application Publication
(10) Pub. No.: US 2005/0136234 A1
(43) Pub. Date: Jun. 23, 2005

(54) Plank for interior use

(76) Inventors: Gijsbertus Hak, Dussen (NL); Barend Willem Hak, Dussen (NL)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/758,851

(22) Filed: Jan. 16, 2004

(30) Foreign Application Priority Data
Dec. 19, 2003 (NL) 1025082

(51) Int. Cl. B32B 7/02; B32B 21/14; B32B 31/06; B32B 31/20

(52) U.S. Cl. 428/215; 428/535; 156/325

(57) ABSTRACT

The present invention is a plank incorporating a base layer with a thickness ranging from 12 to 25 mm, a solid wood top layer, with a thickness ranging from 4.6 to 6 mm, glued to base layer, wherein the base layer is made of a wood based compound, also containing non flammable polymers, hardeners, etc., wherein the wood content of the compound is at least 2% by volume and 95% by volume at maximum, wherein the wood and the polymers are distributed homogeneously, or distributed, depending only on the perpendicular distance to the glued surface, wherein the glue between base layer and top layer is a non flammable glue. The plank of the invention combines the stability and homogeneity of the base layer with the appearance of a solid plank, and moreover has a flame retardant effect, caused by the structure of the product and by the use of fire retardant polymers.

### BENEFIT CLAIM

This application has the right to priority to NL 1025082 filed 19 Dec. 2003.

### FIELD OF THE INVENTION

The invention concerns a board for interior use, e.g. for flooring applications.

### BACKGROUND OF THE INVENTION

Such boards are commonly known. Solid wood planks are known, but they have a disadvantage; they are relatively expensive. Layered planks are also known, composed of a relatively cheap wood-based body, and a layer of veneer, that is glued to the body, but they have the disadvantage that the applied glue is flammable; furthermore, the layer of veneer is very thin, in the range of about 1 to 3 mm. As a consequence, it is not possible to sand the layer of veneer without facing the risk of totally removing it.

### SUMMARY OF THE INVENTION

A purpose of the invention is to provide a plank that lacks the above mentioned disadvantages, and that also has a favorable cost price.

### BRIEF DESCRIPTION OF THE DRAWINGS

The mentioned and other aspects, features and advantages of the present invention will be clarified further by the following discussion of an embodiment of a checkout system according to the present invention while referring to the drawings, in which:

FIG. 1 shows a perspective view of a variant of a plank according to a preferred embodiment of the present invention.

### DETAILED DESCRIPTION OF THE INVENTION

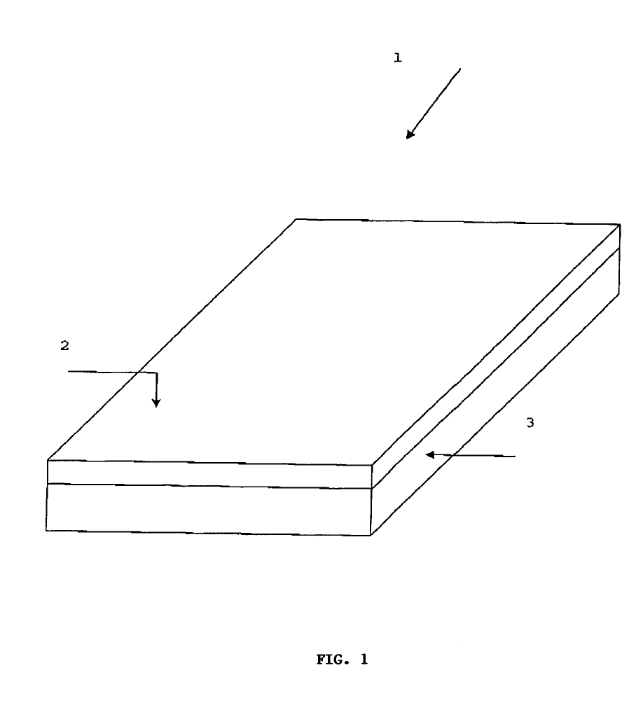

FIG. 1 shows a perspective view of a variant of a plank 1 that is composed of two layers. A base layer 3, in this variant, has a thickness of about 15 mm, but this thickness can range from 12 to 25 mm. A top layer 2 in this variant has a thickness of about 5.9 mm, but this thickness can range from 4.6 to 6 mm. During use the top layer 2 shall be the visible side, meaning the top side when used as floor covering.

The top layer 2 is made of solid wood, e.g. hard wood. Several decorative variants arise from the use of various wood species for the top layer. The resistance to abrasion of the visible side of the plank is also dependent on the wood species, used for the top layer.

Because the thickness of the top layer 2 is large, over 4.6 mm, the plank 1 has the appearance of a solid wooden plank.

The base layer 3 is made of a wood based compound that also contains non-flammable polymers, hardeners, etc. The wood contents are 2% by volume at minimum and 95% by volume at maximum, wherein the wood and the polymers are distributed homogeneously, or distributed, depending only on the distance, perpendicular to the glued surface. Suitable materials for base layer 3 are for instance: MDF (medium density fiberboard), HDF (high density fiberboard), chipboard, OSB (oriented strand board) or plywood (wood-like anisotropic board materials)

Common solid wooden planks tend to warp as a consequence of changing ambient conditions. The relative humidity is the main cause in this. Form and size then are subject to change.

The substrate of this invention has a stabilizing effect, largely reducing the warping effect in the planks.

Base layer 3 and top layer 2 are glued together by a suitable, non flammable glue. Non flammable glues are known, as an example polyurethane and EPI (emulsified polyethylene+isocyanate) are mentioned here. Commonly, layered planks are produced using ordinary, possibly waterproof, adhesives for wood, but these are flammable. By using a non flammable polymer glue according to the invention, in conjunction with the non flammable polymers in base layer 3, the plank has a fire retardant effect.

Joining the components is preferably done at high pressure, in the range between 10 and 100 bar, stimulating the penetration of the polymers. The temperature can be at room temperature, preferably above 10° C., but can also be chosen at a higher level, up to 90° C., increasing process costs (heating) but allowing for a better and quicker gluing process.

As such, the invention provides a plank, that combines the stability and homogeneity of the base layer 3 with the appearance of a solid wooden plank, moreover it has a fire retardant effect because of the product's structure and because fire retardant polymers are used.

An expert shall appreciate, that the invention is not limited to the abovementioned application examples, but that several variants and modifications are possible within the protective scope of the invention as defined in the attached claims.

The thickness of top layer 2 could be more than 6 mm, but then the penetration of the glue in the top layer becomes less sufficient, thus reducing the fire retardant effect.

In order to create an interlocking covering for larger surfaces, the invention can be provided with known techniques, that enable the planks to be mutually joined (like for instance tongue and groove, or otherwise)

The plank can have several layers. As an example, a sub layer (not drawn), preferably made of similar material as top layer (2), and preferably glued in the same way as top layer 2, can be bonded to the lower side of base layer 3, meaning opposite to top layer 2.

1. Plank, comprised of:
a base layer with a thickness ranging from 12 to 25 mm; and
a top layer of solid wood, glued to base layer with a thickness ranging from 4.6 to 6 mm;
wherein the base layer is made of a wood based compound, also containing non flammable polymers, hardeners, etc.;
wherein the wood content of the compound is at least 2% by volume and 95% by volume at most, the wood and the polymers being homogeneously distributed or distributed, depending only on the distance, perpendicular to the glued surface; and
wherein the glue between base layer and top layer is a non flammable glue.

2. Plank according to claim 1, wherein the base layer has a thickness of about 15 mm.

3. Plank according to claim 1, wherein the top layer has a thickness of about 5.9 mm.

4. Plank according to claim 1, wherein the top layer is made of hardwood.

5. Plank according to claim 1, wherein the base layer is made from a material selected from the group consisting of MDF (medium density fiberboard), HDF (high density fiberboard), chipboard, OSB (oriented strand board) and plywood (wood-like anisotropous board materials).

6. Plank according to claim 1, wherein the glue is a polyurethane glue, or an EPI glue.

7. Plank according to claim 1, provided with a technique for mutual joining of planks (like for instance tongue and groove or otherwise).

8. A method of producing a plank according to claim 1, comprising the steps of:
providing a base layer with a thickness ranging from 12 to 25 mm, which base layer is made of a wood based compound, also containing non flammable polymers, hardeners etc., wherein the wood content of the compound is 2% by volume at minimum and 95% by volume at maximum, wherein the wood and the polymers are homogeneously distributed, or distributed, depending only on the perpendicular distance to the glued surface;
providing a top layer made of solid wood with a thickness in the range of 4.6 to 6 mm; and
gluing base layer and top layer together by means of a non flammable glue.

9. A method according to claim 8, wherein base layer and top layer during gluing are pressed together at least for a certain period with a certain pressure higher than 1 bar.

10. A method according to claim 9, wherein mentioned pressure is set between 10 and 100 bar.

11. A method according to claim 8, wherein during gluing at least for a certain period, a temperature is set in the range of 10 to 90° C.
